(19) United States
(12) Patent Application Publication
(10) Pub. No.: US 2024/0322202 A1
(43) Pub. Date: Sep. 26, 2024

(54) ELECTROCHEMICAL CELL

(71) Applicant: DENSO CORPORATION, Kariya-city (JP)

(72) Inventors: GO IIJIMA, Kariya-city (JP); JUNICHI NARUSE, Kariya-city (JP); KYOHEI USAMI, Kariya-city (JP); EIICHI HIROSE, Kariya-city (JP); MIHO SATO, Kariya-city (JP); YUKI FUJITA, Kariya-city (JP)

(21) Appl. No.: 18/600,316

(22) Filed: Mar. 8, 2024

(30) Foreign Application Priority Data
Mar. 23, 2023 (JP) 2023-046829
Dec. 26, 2023 (JP) 2023-219310

(51) Int. Cl. H01M 8/04082; H01M 4/86

(52) U.S. Cl. CPC H01M 8/04216; H01M 4/8621; H01M 2300/0017

(57) ABSTRACT

An electrochemical cell includes a working electrode, a counter electrode, and an electrolyte covering the working electrode and the counter electrode. The working electrode and the counter electrode are configured so that electrons are supplied from the counter electrode to the working electrode and the working electrode absorbs CO₂ in response to a first voltage applied between the working electrode and the counter electrode, and electrons are supplied from the working electrode to the counter electrode and the CO₂ is desorbed from the working electrode in response to a second voltage applied between the working electrode and the counter electrode. The working electrode is made of a metal, and a surface of the working electrode that is to be in contact with the CO₂ containing gas is covered with an oxide film.

### CROSS REFERENCE TO RELATED APPLICATIONS

The present application claims the benefit of priority from Japanese Patent Application No. 2023-046829 filed on Mar. 23, 2023 and Japanese Patent Application No. 2023-219310 filed on Dec. 26, 2023. The entire disclosure of the above applications is incorporated herein by reference.

### TECHNICAL FIELD

The present disclosure relates to an electrochemical cell that adsorbs carbon dioxide.

### BACKGROUND

Conventionally, there has been known an electrochemical cell that recovers CO₂ from a mixed gas containing CO₂ by an electrochemical reaction. In JP 2022-177883 A, the applicant has proposed to concentrate an electric field on an electrode surface without using a redox-active organic substance (for example, anthraquinone) so that CO₂ can be absorbed in its original state without charge transfer to CO₂.

### SUMMARY

According to an aspect of the present disclosure, an electrochemical cell for separating CO₂ from a CO₂ containing gas by an electrochemical reaction includes a working electrode, a counter electrode, and an electrolyte covering the working electrode and the counter electrode. The working electrode and the counter electrode are configured so that electrons are supplied from the counter electrode to the working electrode and the working electrode absorbs CO₂ in response to a first voltage applied between the working electrode and the counter electrode, and electrons are supplied from the working electrode to the counter electrode and the CO₂ is desorbed from the working electrode in response to a second voltage applied between the working electrode and the counter electrode. The working electrode is made of a metal, and a surface of the working electrode that is to be in contact with the CO₂ containing gas is covered with an oxide film.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system of the first embodiment;

FIG. 2 is a diagram illustrating a carbon dioxide recovery device;

FIG. 3 is a cross-sectional view of an electrochemical cell;

FIG. 4A is a diagram for explaining the operation of the CO₂ recovery device in a CO₂ recovery mode;

FIG. 4B is a diagram for explaining the operation of the CO₂ recovery device in a CO₂ discharge mode;

FIG. 5 is a diagram showing current efficiencies of electrochemical cells in Examples 1-28;

FIG. 6 is a diagram showing current efficiencies of electrochemical cells in Examples 29-56;

FIG. 7 is a diagram showing current efficiencies of electrochemical cells in Examples 57-84; and

FIG. 8 is a diagram showing current efficiencies of electrochemical cells in Examples 85-94 and Comparative Examples 1-5.

### DETAILED DESCRIPTION

When an electrochemical cell is operated in the presence of O₂ such as air, charge transfer to O₂ occurs, and superoxide O₂_{^{−}}, which is a kind of active oxygen, is generated. This generation of O₂ lowers a current efficiency, which indicates the amount of CO₂ adsorbed per electron. Furthermore, O₂, which has high reaction activity, decomposes organic materials in the electrochemical cell, such as electrolyte and binder.

According to an aspect of the present disclosure, an electrochemical cell for separating CO₂ from a CO₂ containing gas by an electrochemical reaction includes a working electrode, a counter electrode, and an electrolyte covering the working electrode and the counter electrode. The working electrode and the counter electrode are configured so that electrons are supplied from the counter electrode to the working electrode and the working electrode absorbs CO₂ in response to a first voltage applied between the working electrode and the counter electrode, and electrons are supplied from the working electrode to the counter electrode and the CO₂ is desorbed from the working electrode in response to a second voltage applied between the working electrode and the counter electrode. The working electrode is made of a metal, and a surface of the working electrode that is to be in contact with the CO₂ containing gas is covered with an oxide film.

In the above-described electrochemical cell, since the working electrode is made of the metal and the surface of the working electrode that is to be in contact with the CO₂ containing gas is covered with the oxide film, the generation of active oxygen from O₂ contained in CO₂ containing gas can be restricted, and the decrease in current efficiency when CO₂ is adsorbed on the working electrode can be restricted.

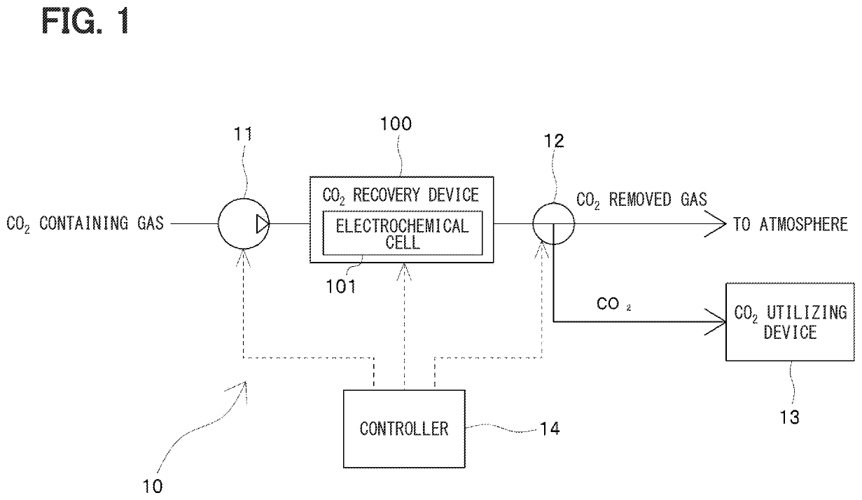

The following describes a first embodiment of the present disclosure with reference to the drawings. As shown in FIG. 1, a carbon dioxide recovery system 10 of the present embodiment includes a compressor 11, a carbon dioxide recovery device 100, a passage switching valve 12, a carbon dioxide utilizing device 13, and a controller 14.

The compressor 11 pumps a CO₂ containing gas to the carbon dioxide recovery device 100. The CO₂ containing gas is a mixed gas containing CO₂ and a gas other than CO₂, and for example, the atmosphere or exhaust gas of an internal combustion engine can be used as the CO₂ containing gas.

The carbon dioxide recovery device 100 is a device that separates and recovers CO₂ from the CO₂ containing gas. The carbon dioxide recovery device 100 discharges a CO₂ removed gas that is gas after CO₂ is recovered from the CO₂ containing gas, or CO₂ recovered from the CO₂ containing gas. The configuration of the carbon dioxide recovery device 100 will be described in detail later.

The passage switching valve 12 is a three-way valve that switches a passage of exhaust gas from the carbon dioxide recovery device 100. The passage switching valve 12 switches the passage of the exhaust gas toward the atmosphere when the CO₂ removed gas is discharged from the carbon dioxide recovery device 100, and switches the passage of the exhaust gas toward the carbon dioxide utilizing device 13 when CO₂ is discharged from the carbon dioxide recovery device 100.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a passage switching control of the passage switching valve 12 and the like.

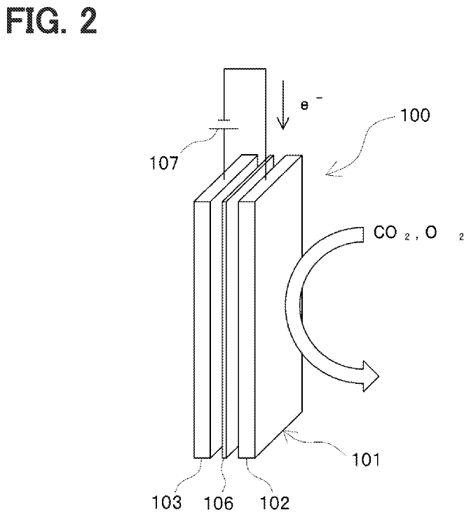

Next, the carbon dioxide recovery device 100 will be described with reference to FIG. 2. As shown in FIG. 2, the carbon dioxide recovery device 100 includes an electrochemical cell 101 configured to adsorb and desorb CO2 by electrochemical reactions. The electrochemical cell 101 includes a working electrode 102, a counter electrode 103 and an insulating layer 106. In the example shown in FIG. 2, the working electrode 102, the counter electrode 103 and the insulating layer 106 are each formed in a plate shape. In FIG. 2, the working electrode 102, the counter electrode 103, and the insulating layer 106 are illustrated to have a distance therebetween, but actually, these components are arranged so as to be in contact with each other.

The electrochemical cell 101 may be housed in a container (not shown). The container may define a gas inlet for introducing the CO₂ containing gas into the container and a gas outlet for discharging the CO₂ removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂ containing gas. The carbon dioxide recovery device 100 includes a power supply 107 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

The electrochemical cell 101 can be switched between a CO₂ recovery mode in which CO₂ is recovered at the working electrode 102 and a CO₂ discharge mode in which CO₂ is discharged from the working electrode 102 by changing the potential difference between the working electrode 102 and the counter electrode 103. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 102 and the counter electrode 103, and electrons flows from the counter electrode 103 to the working electrode 102. At the first voltage V1, the counter electrode potential is greater than the working electrode potential. The first voltage V1 may fall within a range from 0.5 to 2.0 V.

In the CO₂ discharge mode, a second voltage V2 is applied between the working electrode 102 and the counter electrode 103, and electrons flows from the working electrode 102 to the counter electrode 103. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

In the electrochemical cell 101 of the present embodiment, when a voltage is applied between the working electrode 102 and the counter electrode 103, an electric double layer is formed by electrons and ions contained in an electrolyte 108. In the CO₂ recovery mode, when cations of the electrolyte 108 move to the vicinity of the working electrode 102 and anions of the electrolyte 108 move to the vicinity of the counter electrode 103, a potential difference is formed between the vicinity of the respective surfaces, and electrons are supplied from the counter electrode 103 to the working electrode 102. In the CO₂ discharge mode, anions of the electrolyte 108 move to the vicinity of the working electrode 102, cations of the electrolyte 108 move to the vicinity of the counter electrode 103, and electrons are supplied from the working electrode 102 to the counter electrode 103.

In the present embodiment, a metal electrode is used as the working electrode 102. The metal electrode of the present embodiment is a porous metal body and has a large number of pores through which CO₂ containing gas can pass. As the metal porous body, a metal structure having a form such as foamed metal, sintered metal, metal nonwoven fabric, metal woven fabric, or the like can be used.

The foamed metal is a metal structure in which many small pores are formed by gas. The sintered metal is a metal structure made by sintering metal powder at a temperature lower than its melting point. The metal nonwoven fabric is a metal structure in which metal fibers are entangled in a non-oriented manner by needle punching or the like. Examples of the metal nonwoven fabric include metal felt, metal wool, and the like. The metal woven fabric is a metal structure made by weaving metal fibers vertically and horizontally into a woven fabric. The metal woven fabric may be in the form of a cross extending vertically and horizontally or in the form of an elongated strip.

The metal electrode constituting the working electrode 102 functions as a CO₂ adsorbent. Therefore, the working electrode 102 is not provided with a CO₂ adsorbent such as a redox-active organic substance. In other words, the working electrode 102 is not provided with an active material that transfers electrons through a redox reaction.

In the present embodiment, a metal electrode having an oxide film 102a on a surface thereof is adopted as the working electrode 102. That is, the oxide film 102a is formed on a surface of the working electrode 102 that is in contact with the CO₂ containing gas. The surface of the working electrode 102 that comes into contact with the CO₂ containing gas includes inner surfaces of the pores of the porous metal body that constitutes the working electrode 102.

As the metal constituting the metal electrode, a single metal element or an alloy containing multiple types of metals can be used. As the metal constituting the metal electrode, for example, an iron-based material with an iron element (Fe) content of 50 to 100% can be used. Such iron-based materials containing iron as a main component include pure iron, steel, cast iron, and the like. Steel includes carbon steel and alloy steel. Examples of alloy steel include stainless steel (SUS). In the following description, carbon steel is also simply referred to as iron.

The stainless steel is an alloy containing multiple metals. The stainless steel is an alloy steel containing iron as a main component, 1.2% or less of carbon, and 10.5% or more of chromium. As the working electrode 102, any type of stainless steel including austenitic stainless steel and ferritic stainless steels can be used. In the present embodiment, at least one stainless steel selected from a group consisting of SUS316L, SUS316, SUS304L, SUS304, SUS310S, SUS430, SUS434, and SUS444 is used.

On the surface of iron, the oxide film 102a made of iron oxide is formed. On the surface of the stainless steel, the oxide film 102a made of an oxide of chromium, iron, or the like is formed. The oxide film 102a described above is inert to O₂ and has extremely low reactivity to O₂. Therefore, even if O₂ contained in the CO₂ containing gas comes into contact with the working electrode 102, charge transfer to O₂ can be restricted, and the generation of O₂ can be restricted. Even if O₂_{^{−}} is generated at the working electrode 102, O₂_{^{−}} reacts efficiently with CO₂, and excessive charge transfer to O₂ can be restricted. As a result, CO₂ can be adsorbed and desorbed at the working electrode 102 with high current efficiency even in the presence of O₂. The current efficiency is expressed as a percentage of the number of adsorbed CO₂ to the number of electrons flowing from the counter electrode 103 to the working electrode 102 during CO₂ adsorption.

In the metal having the oxide film 102a, the conductivity of the oxide film 102a is lower than the conductivity of the other part. Therefore, it is preferable that the oxide film 102a of the metal electrode used as the working electrode 102 is as thin as possible in order to improve conductivity. In the present embodiment, a thickness of the oxide film 102a is 10 nm or less. Since the metal electrode made of stainless steel is mostly composed of a metal part other than the oxide film, sufficient conductivity can be ensured. It is preferable that the thickness of the oxide film 102a is 1 nm or more.

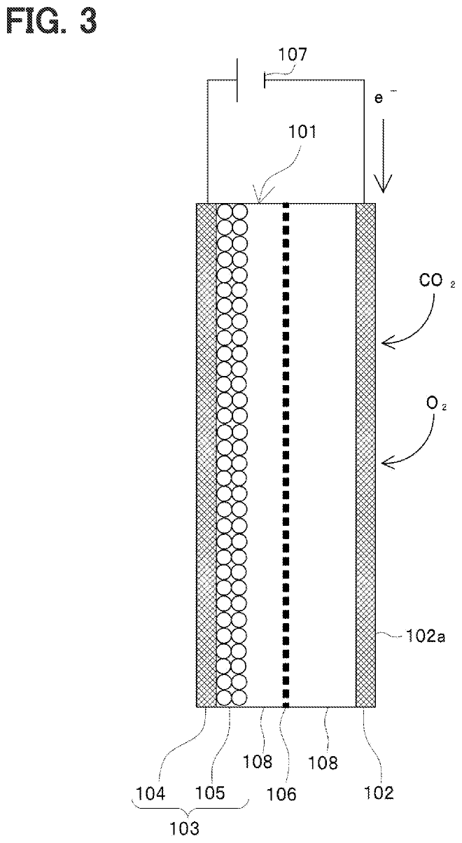

As shown in FIG. 3, the counter electrode 103 includes a counter electrode base member 104 and a counter electrode active material 105.

The counter electrode base member 104 is a conductive material. As the counter electrode base member 104, for example, a carbonaceous material or a metal material can be used. As the carbonaceous material constituting the counter electrode base member 104, for example, carbon paper, carbon cloth, non-woven carbon mat, porous gas diffusion layer (GDL) and the like can be used.

The counter electrode active material 105 is an auxiliary electroactive species that exchanges electrons with the working electrode 102 . The counter electrode active material 105 may be, for example, a metal complex that can receive and release electrons by changing a valence of a metal ion. Examples of such metal complex include cyclopentadienyl metal complexes such as ferrocene, nickelocene and cobaltocene, and porphyrin metal complexes. These metal complexes may be polymers or monomers. In the present embodiment, polyvinylferrocene is used as the counter electrode active material 105. Ferrocene transfers electrons by changing the valence of Fe into divalent or trivalent.

The counter electrode active material 105 is added with a conductive material and a binder. The conductive material forms a conductive path to the counter electrode active material 105. The conductive material may be, for example, a carbon material such as carbon nanotube, carbon black, or graphene. The binder may be any material as long as it can hold the counter electrode active material 105 on the counter electrode base member 104 and has electrical conductivity. The binder may be a conductive resin such as an epoxy resin and a fluoropolymer, containing Ag or the like as a conductive filler. The fluoropolymer may be, for example, polytetrafluoroethylene (PTFE), or polyvinylidene fluoride (PVDF).

The insulating layer 106 is disposed between the working electrode 102 and the counter electrode 103, and separates the working electrode 102 and the counter electrode 103 from each other. The insulating layer 106 is an insulating ion permeable membrane that prevents physical contact between the working electrode 102 and the counter electrode 103 to restrict an electrical short circuit and that allows ions to permeate therethrough.

As the insulating layer 106, a separator or a gas layer such as air can be used. In the present embodiment, a porous separator is used as the insulating layer 106. As the material of the separator, a cellulose membrane, a polymer, a composite material of a polymer and a ceramic, or the like can be used.

The electrolyte 108 having ionic conductivity is disposed between the working electrode 102 and the counter electrode 103. The electrolyte 108 is disposed between the working electrode 102 and the counter electrode 103 via the insulating layer 106. The electrolyte 108 covers the working electrode 102, the counter electrode 103 and the insulating layer 106.

In the present embodiment, an aprotic electrolyte is used as the electrolyte 108. The aprotic electrolyte is an electrolyte that does not donate protons (H⁺). Therefore, charges do not move to the electrolyte 108 due to proton generation, and the decrease in current efficiency during CO₂ adsorption can be restricted.

An ionic liquid can be used as the electrolyte 108 having an aprotic property. The ionic liquid is a salt of a liquid having non-volatility under normal temperature and pressure. When the ionic liquid is used as the electrolyte 108, the ionic liquid may be gelled to prevent elution of the ionic liquid from the electrochemical cell 101. As the ionic liquid having an aprotic property, [BMIM][TFSI], [TMPA][TFSI], [Pyrro][TFSI], [BMIM][Tfb], [EMIM][TFSI], [N4441][TFSI] or the like can be used.

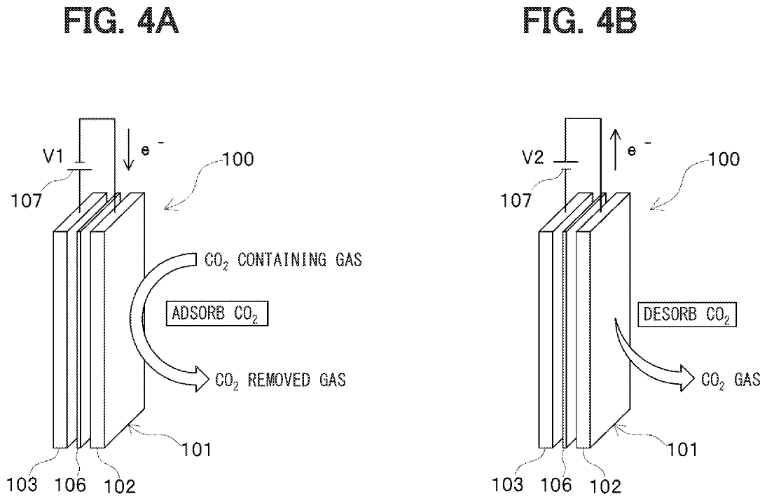

Next, the operation of the carbon dioxide recovery system 10 of the present embodiment will be described. The carbon dioxide recovery system 10 operates by alternately switching between the CO₂ recovery mode shown in FIG. 4A and the CO₂ discharge mode shown in FIG. 4B. The operation of the carbon dioxide recovery system 10 is controlled by the controller 14.

First, the CO₂ recovery mode will be described. In the CO₂ recovery mode, the compressor 11 operates to supply the CO₂ containing gas to the carbon dioxide recovery device 100. In the carbon dioxide recovery device 100, the voltage applied between the working electrode 102 and the counter electrode 103 is the first voltage V1. This makes it possible to simultaneously realize electron donation of the counter electrode active material 105 of the counter electrode 103 and electron attraction of the working electrode 102. The counter electrode active material 105 of the counter electrode 103 discharges electrons to be oxidized, and the electrons are supplied from the counter electrode 103 to the working electrode 102.

The working electrode 102 that has received the electrons adsorbs CO₂ contained in the CO₂ containing gas. Thus, the carbon dioxide recovery device 100 can recover CO₂ from the CO₂ containing gas. Since the oxide film formed on the surface of the metal electrode of the working electrode 102 is inert to O₂, even if the CO₂ adsorbed gas comes into contact with the working electrode 102, it can be restricted that charges are transferred to the O₂ contained in the CO₂ adsorbed gas to generate O₂_{^{−}}, which is active oxygen.

After CO₂ is recovered from the CO₂ containing gas by the carbon dioxide recovery device 100, the CO₂ containing gas is discharged from the carbon dioxide recovery device 100 as the CO₂ removed gas containing no CO₂. The passage switching valve 12 switches the passage of exhaust gas toward the atmosphere, and the CO₂ removed gas from the carbon dioxide recovery device 100 is discharged to the atmosphere.

Next, the CO₂ discharge mode will be described. In the CO₂ discharge mode, the operation of the compressor 11 is stopped, and the supply of the CO₂ containing gas to the carbon dioxide recovery device 100 is stopped. In the carbon dioxide recovery device 100, the voltage applied between the working electrode 102 and the counter electrode 103 is the second voltage V2. This makes it possible to simultaneously realize electron donation of the working electrode 102 and electron attraction of the counter electrode active material 105 of the counter electrode 103. The counter electrode active material 105 of the counter electrode 103 receives electrons to be reduced.

The working electrode 102 discharges electrons and desorbs CO₂. The CO₂ discharged from the working electrode 102 is discharged from the carbon dioxide recovery device 100. The passage switching valve 12 switches the passage of the exhaust gas toward the carbon dioxide utilizing device 13, and the CO₂ discharged from the carbon dioxide recovery device 100 is supplied to the carbon dioxide utilizing device 13.

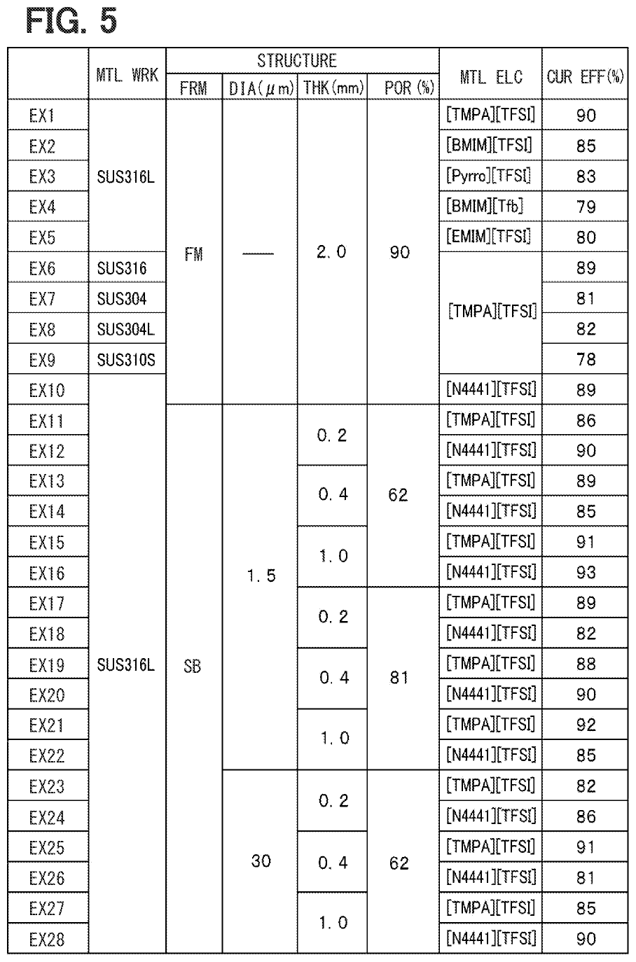

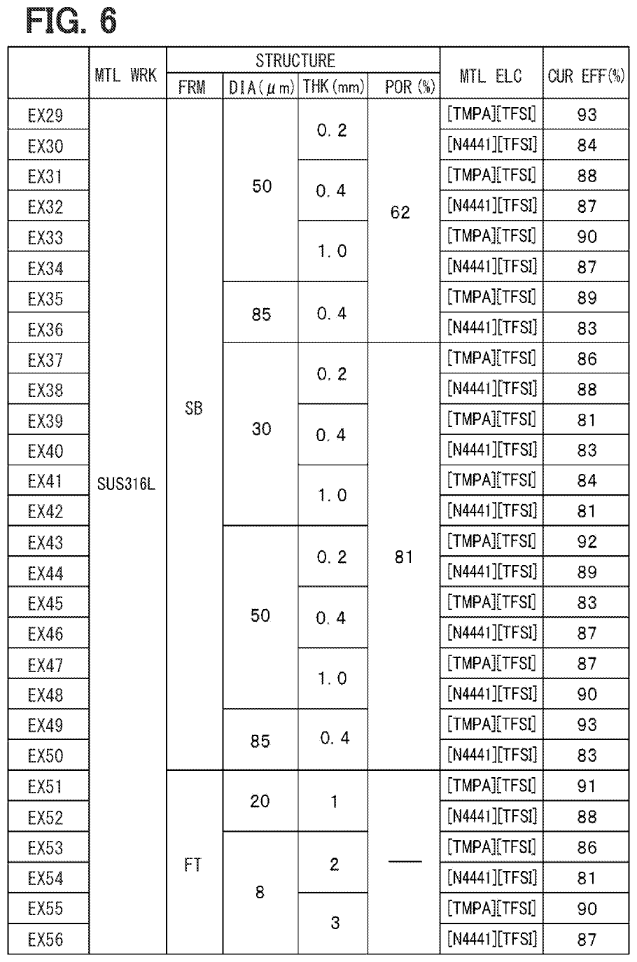

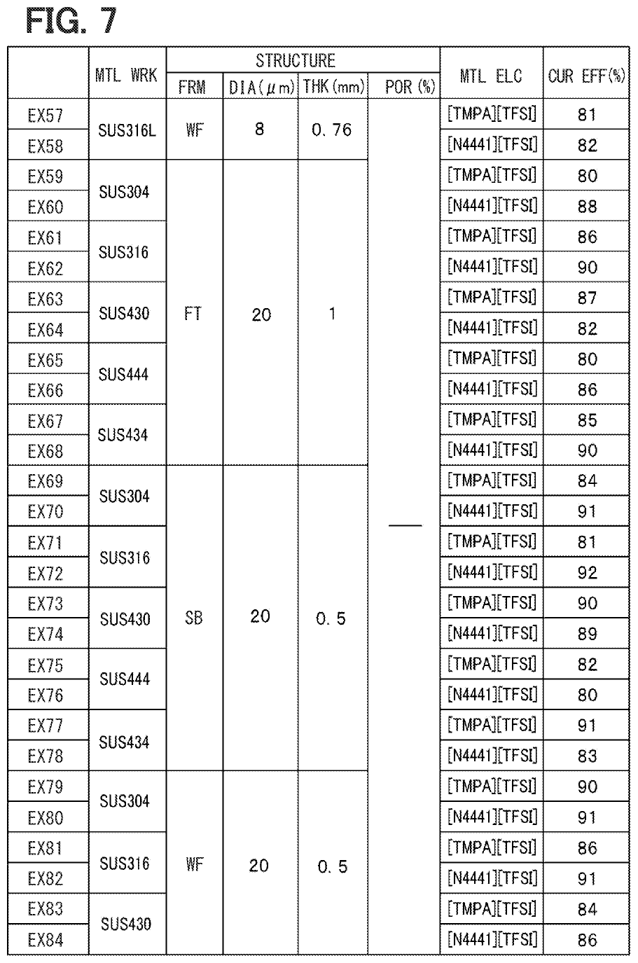

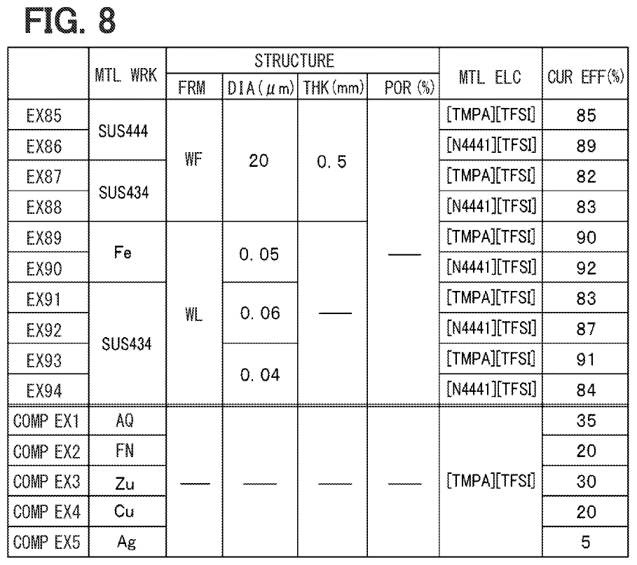

Next, a current efficiency when CO₂ is adsorbed by the electrochemical cell 101 of the present embodiment will be explained using Examples 1 to 94 and Comparative Examples 1 to 5 shown in FIG. 5, FIG. 6, FIG. 7, and FIG. 8. FIGS. 5 to 8 show a material of the working electrode 102 (MTL WRK), a form of the working electrode 102 (FRM), a fiber diameter of the working electrode 102 (DIA), a film thickness of the working electrode 102 (THK), a porosity of the working electrode 102 (POR), a material of the electrolyte 108 (MTL ELC), and a current efficiency (CUR EFF) of an electrochemical cell in each of Examples 1 to 94 and Comparative Examples 1 to 5.

For the working electrode 102 of each of Examples 1 to 9, a stainless steel foam (FM) with a film thickness of 2.0 mm and a porosity of 90% was used. In each of Examples 1 to 5, SUS316L was used as the material of the working electrode 102, and [TMPA][TFSI], [BMIM][TFSI], [Pyrro][TFSI], [BMIM][Tfb], or [EMIM][TFSI] was used as the material of the electrolyte 108. In Example 6, SUS316 was used as the material of the working electrode 102. In Example 7, SUS304 was used as the material of the working electrode 102. In Example 8, SUS304L was used as the material of the working electrode 102. In Example 9, SUS310S was used as the material of the working electrode 102. In each of Examples 6 to 9, [TMPA][TFSI] was used as the material of the electrolyte 108.

In each of Examples 10 to 50, SUS316L was used as the material of the working electrode 102, and [TMPA][TFSI] or [N4441][TFSI] was used as the material of the electrolyte 108. For the working electrode 102 of each of Examples 10 to 50, a stainless steel sintered body (SB) having a fiber diameter of 1.5 μm, 30 μm, 50 μm, or 85 μm, a film thickness of 0.2 mm, 0.4 mm, or 1.0 mm, and a porosity of 62% or 81% was used.

In each of Examples 51 to 58, SUS316L was used as the material of the working electrode 102, and [TMPA][TFSI] or [N4441][TFSI] was used as the material of the electrolyte 108. In each of Examples 51 to 56, a stainless steel felt (FT) with a fiber diameter of 20 μm or 8 μm and a film thickness of 1 mm, 2 mm, or 3 mm was used. In each of Examples 57 and 58, a belt-shaped (that is, tape-shaped) stainless steel woven fabric (WF) having a fiber diameter of 8 μm and a film thickness of 0.76 mm was used.

In each of Examples 59 to 88, SUS304, SUS316, SUS430, SUS444, or SUS434 was used as the material of the working electrode 102, and [TMPA][TFSI] or [N4441][TFSI] was used as the material of the electrolyte 108. In each of Examples 59 to 68, a stainless steel felt with a fiber diameter of 20 μm and a film thickness of 1 mm was used. In each of Examples 69 to 78, a stainless steel sintered body having a fiber diameter of 20 μm and a film thickness of 0.5 mm was used. In each of Examples 79 to 88, a stainless steel woven fabric with a fiber diameter of 20 μm and a film thickness of 0.5 mm was used.

In each of Examples 89 to 94, iron or SUS434 was used as the material of the working electrode 102, and [TMPA][TFSI] or [N4441][TFSI] was used as the material of the electrolyte 108. In each of Examples 89 and 90, a steel wool (WL) with a fiber diameter of 0.05 μm was used. In each of Examples 90 to 94, a stainless wool having a fiber diameter of 0.04 μm or 0.06 μm was used.

In each of Comparative Examples 1 to 5, anthraquinone (AQ), fluorenone (FN), Zu, Cu, or Ag was used as the material of the working electrode 102, and [TMPA][TFSI] was used as the material of the electrolyte 108.

As shown in FIGS. 5 to 8, in each of Examples 1 to 94 in which iron or stainless steel was used as the material of the working electrode 102, the current efficiency was within a range from 78 to 93%. The working electrode 102 was able to obtain high current efficiency even if the working electrode 102 was the porous body in any form such as the foam, the sintered body, the felt, the woven fabric, or the wool. On the other hand, in each of Comparative Examples 1 to 5 in which the working electrode 102 was made of anthraquinone, fluorenone, Zu, Cu, or Ag, the current efficiency was within a range from 5 to 35%. As described above, in each of Examples 1 to 94 in which iron or various types of SUS was used for the working electrode 102, higher current efficiency could be obtained than in each of Comparative Examples 1 to 5.

According to the present embodiment described above, by using the metal electrode having the oxide film as the working electrode 102, the generation of active oxygen from O₂ contained in the CO₂ containing gas can be restricted, and the decrease in current efficiency when CO₂ is adsorbed on the working electrode 102 can be restricted. Furthermore, by restricting the generation of active oxygen, decomposition of the organic materials in the electrochemical cell 101 can be restricted.

Furthermore, in the present embodiment, the working electrode 102 does not include an active material made of an organic material, and even if active oxygen is generated in the working electrode 102, oxidative decomposition of an active material does not occur. Therefore, the decrease in the amount of CO₂ adsorbed by the electrochemical cell 101 due to oxidative decomposition of the active material of the working electrode 102 can be restricted.

In the present embodiment, the aprotic electrolyte is used as the electrolyte 108. Therefore, charges do not move to the electrolyte 108 due to proton generation, and the decrease in current efficiency during CO₂ adsorption can be restricted.

### Other Embodiments

The present disclosure is not limited to the above-described embodiment, and various modifications can be made without departing from the spirit of the present disclosure.

For example, in the above-described embodiment, examples have been described in which stainless steel is used as the metal with an oxide film formed thereon for the working electrode 102, but a metal other than stainless steel with an oxide film formed thereon may be used.

Furthermore, in the above-described embodiment, SUS316L and the like have been listed as the stainless steel used for the working electrode 102, but stainless steel other than the listed types may also be used.

What is claimed is:

1. An electrochemical cell for separating CO₂ from a CO₂ containing gas by an electrochemical reaction, the electrochemical cell comprising:
a working electrode;
a counter electrode; and
an electrolyte covering the working electrode and the counter electrode, wherein
the working electrode and the counter electrode are configured so that electrons are supplied from the counter electrode to the working electrode and the working electrode absorbs CO₂ in response to a first voltage applied between the working electrode and the counter electrode, and electrons are supplied from the working electrode to the counter electrode and the CO₂ is desorbed from the working electrode in response to a second voltage applied between the working electrode and the counter electrode, and
the working electrode is made of a metal, and a surface of the working electrode that is to be in contact with the CO₂ containing gas is covered with an oxide film.

2. The electrochemical cell according to claim 1, wherein
the metal is an iron-based material with an iron element content of 50 to 100%.

3. The electrochemical cell according to claim 2, wherein
the metal is an alloy containing a plurality of types of metals.

4. The electrochemical cell according to claim 3, wherein
the metal is stainless steel.

5. The electrochemical cell according to claim 4, wherein
the stainless steel is at least one selected from a group consisting of SUS316L, SUS316, SUS304L, SUS304, SUS310S, SUS430, SUS434, and SUS444.

6. The electrochemical cell according to claim 1, wherein
the electrolyte is an aprotic electrolyte.

7. The electrochemical cell according to claim 6, wherein
the aprotic electrolyte is at least one ionic liquid selected from a group consisting of [BMIM][TFSI], [TMPA][TFSI], [Pyrro][TFSI], [BMIM][Tfb], [EMIM][TFSI], and [N4441][TFSI].
